(19) United States
(12) Patent Application Publication
(10) Pub. No.: US 2026/0253182 A1
(43) Pub. Date: Aug. 27, 2026

(54) GENERATIVE VIDEO ARTIFACT REMOVAL

(71) Applicant: Sima Labs, Inc., REDMOND, WA (US)

(72) Inventors: SOPHIE RANIWALA, PARKLAND, FL (US); RUSHAAN MAHAJAN, REDMOND, WA (US)

(73) Assignee: Sima Labs, Inc., REDMOND, WA (US)

(21) Appl. No.: 19/063,481

(22) Filed: Feb. 26, 2025

(51) Int. Cl. G06T 5/70; G06T 5/10; G06T 5/50

(52) U.S. Cl. CPC G06T 5/70; G06T 5/10; G06T 5/50; G06T 2207/10016; G06T 2207/20052; G06T 2207/20084

(57) ABSTRACT

Generative AI model-created video differs fundamentally from natural video, as it is generated through statistical algorithms rather than captured through a camera-based device. Such content has spatial and temporal (multi-frame) artifacts which are unique to generative video. Described herein is a post-processing method to improve the visual quality of GenAI-produced video content by reducing said artifacts before the video encoding stage. By addressing both global and local flicker (temporal artifacts) as well as unique high frequency noise (spatial artifacts) through frequency domain analysis, the performance of video codecs on processed GenAI videos is optimized, thereby improving compression rates (cost of streaming) and Quality of Experience (QoE).

### FIELD OF THE INVENTION

This invention relates in general to reducing artifacts in videos, and specifically relates to enhancing frame stabilization and structural consistency, thereby improving both the quality of the video and the efficacy of existing video compression techniques on processed generative artificial intelligence (Gen-AI) content.

### BACKGROUND OF THE INVENTION

Flicker refers to unintentional brightness and intensity changes between frames, which are distracting to the viewer and reduce the visual appeal of the video. Traditional deflickering methods are optimized for predictable flicker from periodic light sources (e.g., a computer screen) which emit light at a frequency which doesn't align with the camera's rate of frame capture. In contrast, non-periodic flicker frequently occurs in AI-generated video due to model artifacts rather than lighting conditions/camera-induced inconsistencies. This flicker arises because generative video models often reconstruct frames individually or with only weak temporal constraints. As a result, subtle inconsistencies in details, lighting, or motion accumulate over time, leading to perceptible flickering and temporal artifacts. Beyond global luminance flicker, generative artificial intelligence (GenAI) content can contain slight, unintended positional changes of objects between frames, causing ghosting and blurring after undergoing compression. There is an unmet need to efficiently identify and correct such artifacts in AI generated video.

Removing high-frequency noise is a common technique for enhancing video quality and improving compressibility, as these frequencies often contain unimportant or distracting signals. However, they can also encode essential details, making it crucial to selectively preserve meaningful content while suppressing unwanted noise- or even redistributing the image signal to achieve a more visually coherent result. GenAI video models produce frequency distributions in DCT-transformed frames that deviate from natural content. Consequently, traditional denoising algorithms, optimized for natural video, fail to achieve optimal performance on AI-generated footage. To address this, there is a need for a differentiable approach to model and correct high-frequency noise for GenAI content, effectively reducing artifacts while retaining important structural details.

### SUMMARY OF THE INVENTION

This summary is provided to introduce a selection of concepts in a simplified form that are further disclosed in the detailed description of the invention. This summary is not intended to determine the scope of the claimed subject matter.

A neural network, hereafter called ArtifactNet, is designed to correct visual artifacts in generative AI (GenAI) videos, specifically targeting frame stabilization and noise removal before the video encoding stage. GenAI videos, unlike natural camera-captured content, exhibit unique temporal and spatial artifacts such as flicker and high-frequency noise due to the generative models that create them. This invention addresses a significant unmet need: the efficient identification and correction of flicker and noise artifacts in AI-generated videos. This has the effect of reducing GenAI-video file sizes, enabling optimized compression and playback quality.

The temporal component of this invention corrects multiple types of flicker using a neural network that operates on multiple scales to address global luminance and localized positional inconsistencies (jittering). The deflickering module is tailored to address the unpredictable temporal flicker patterns found in GenAI content, which standard deflickering approaches fail to fix, as they typically focus on global periodic luminance flicker. By teaching the neural network to learn an extremely compressed representation of the motion in the video while iteratively refining its representations at multiple spatial and temporal scales, ArtifactNet is able to isolate the important motion from the jitter and flicker. This provides a robust solution for frame stability across many genres of GenAI video content.

The distributions of high-frequency components (and therefore high-frequency noise) differ between natural and generative video. Within ArtifactNet, the Discrete Cosine Transform (DCT)-based regularization technique spatially refines video quality by filtering non-essential high-frequency noise while preserving crucial visual details. It was empirically determined that high-frequency components in GenAI content follow a distribution with significantly lower kurtosis than natural content, making the overall distribution more uniform and predictable. This suggests that a significant portion of the high frequency components contain noise rather than meaningful detail, and can therefore be more strongly regularized without risking losing visual fidelity. ArtifactNet's spatial component is explicitly tuned to the unique noise distributions of GenAI content.

The invention's dual structure enables application in all types of generative video, effectively removing jitter, ghosting, and banding effects which would otherwise occur when encoding videos that contain the aforementioned spatial and temporal artifacts. By integrating techniques tailored to GenAI's unique artifact patterns, ArtifactNet successfully post-processes GenAI video in a way which delivers smoother transitions, sharper visuals, and a seamless viewing experience. This not only improves visual quality but also enhances the efficiency of video codecs, optimizing generative video outputs for compression and playback. ArtifactNet inherently remains agnostic to the model used for video generation and the subsequent codec used for compression, delivering quality improvements and bandwidth savings in a wide range of deployment scenarios.

Described herein is a system comprising at least one processor; a non-transitory computer readable storage medium communicatively coupled to the processor, the non-transitory computer readable storage medium configured to store modules, the processor configured to execute the following modules.

A first module for applying an end-to-end trained temporal neural network to the generative artificial intelligence produced video content to detect and correct flicker patterns, wherein global flicker is classified as multiplicative or additive errors, and local flicker is detected as unintentional object jitter. Applying the temporal neural network across the generative artificial intelligence produced video content, distinguishing between true object motion and flicker artifacts, and stabilizing brightness inconsistencies while preserving motion integrity. Ensuring frame-to-frame coherence by reconstructing each frame of the generative artificial intelligence produced video content's visual context and correcting unintended positional variations, thereafter producing a stabilized temporally corrected output.

A second module for passing the stabilized temporally corrected output into a spatial neural network trained to enhance color consistency, suppress high-frequency noise, and refine luminance and chrominance channels through convolutional and cross-channel operations.

A third module for applying frequency-adaptive discrete cosine transform (DCT)-based regularization to said temporally corrected output, selectively filtering non-essential noise while retaining perceptual detail. Thereby, generating a fully refined video output where temporal and spatial artifacts have been minimized, ensuring optimal video quality for encoding and playback.

### BRIEF DESCRIPTION OF THE DRAWINGS

The foregoing summary, as well as the following detailed description of the invention, is better understood when read in conjunction with the appended drawings. For illustrating the invention, exemplary constructions of the invention are shown in the drawings. However, the invention is not limited to the specific components disclosed herein. The description of a component referenced by a numeral in a drawing is applicable to the description of that component shown by that same numeral in any subsequent drawing herein.

FIG. 1 is a visualization of two-different cases of GenAI video degradation in the spatial domain with the cases of Jittering and Luma/Chroma flickering in accordance with an embodiment of the inventive concepts.

FIG. 2 illustrates an end-to-end method of correcting global flicker in accordance with an embodiment of the inventive concepts.

FIG. 3 illustrates a method of high frequency noise suppression in accordance with an embodiment of the inventive concepts.

FIG. 4 illustrates the Temporal+Spatial modules integrated together in full processing in accordance with an embodiment of the inventive concepts.

FIG. 5 illustrates a method for pre-processing generative AI produced video content to correct visual artifacts prior to encoding in accordance with an embodiment of the inventive concepts.

FIG. 6 illustrates the end-to-end spatial branch of the convolutional neural network in accordance with an embodiment of the inventive concepts.

### DETAILED DESCRIPTION OF THE PREFERRED EMBODIMENTS

ArtifactNet is defined herein as a specialized neural network designed to correct visual artifacts in generative AI (GenAI) videos, focusing on frame stabilization and noise reduction before the encoding stage. GenAI videos exhibit distinct temporal and spatial distortions, such as flickering and high-frequency noise, in a manner that differs from naturally captured footage. This results from the architecture of the generative models that produce such videos. This innovation addresses a critical challenge: efficiently identifying and correcting these artifacts to enhance video quality, reduce file sizes, and optimize compression and playback.

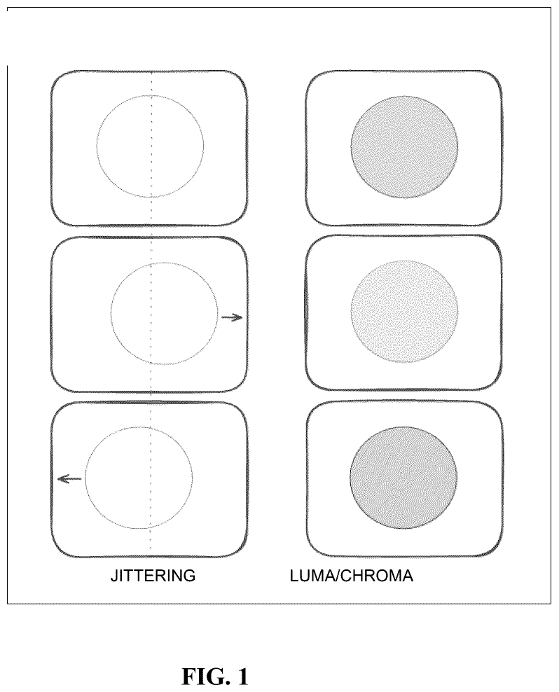

FIG. 1 is a visualization of two-different cases of GenAI Video degradation in the spatial domain with the cases of Jittering and Luma/Chroma flickering. Jittering is an artifact seen in many generative video models that happens as result of spatial misalignment that results in perceptible positional instability across frames. Meanwhile, Luma/Chroma flickering is a result of inconsistent generative sampling leading to frame-to-frame luminance and color fluctuations.

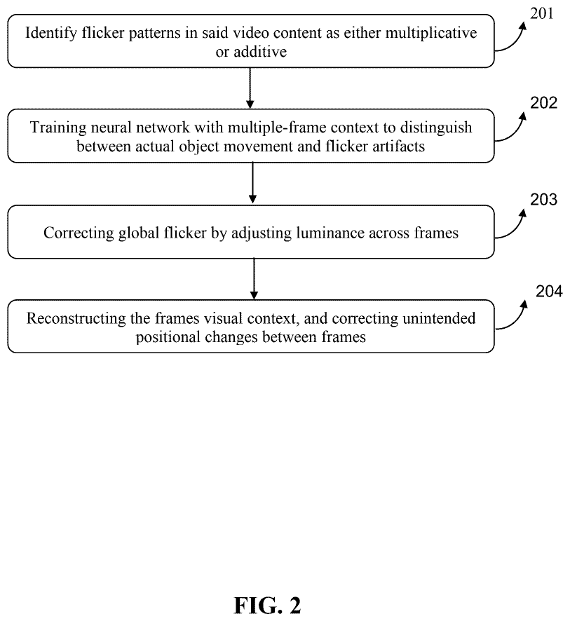

FIG. 2 illustrates an end-to-end method of correcting global flicker. This method ensures that both global luminance inconsistencies 203 and localized positional instabilities are addressed simultaneously, preventing artifacts from propagating through subsequent frames. By leveraging a neural network trained 202 with multi-frame temporal awareness, the system can differentiate between true motion dynamics and unintended flicker, leading to more stable and visually coherent GenAI video output.

The method of temporal artifact correction is described herein. ArtifactNet employs a multi-scale approach to correct various forms of flicker, tackling both global luminance inconsistencies (multiplicative and additive perturbations 201 to frequency coefficients) and localized positional distortions (jittering). Unlike conventional deflickering methods, which struggle with the unpredictable temporal variations in GenAI videos and local jitter, ArtifactNet learns how to fully reconstruct frames 204 and iteratively refine its representations across multiple spatial and temporal scales to rectify such artifacts while preserving the creator's artistic intent. This ensures improved frame stability and smooth transitions between frames. Not only does this improve the visual appeal of the video, it also improves the compressibility of the content by traditional codecs. Jitter and flicker artifacts introduce additional unnecessary information which must be encoded by motion vectors, thereby worsening the overall compression rates.

Internally, the temporal branch learns to create a highly compressed representation of the motion within the video. This effectively isolates the important motion information from the unwanted motion artifacts, allowing positional changes to be rectified by accurately reconstructing the frame. Flicker can also manifest as global intensity variations across frames. This can be corrected with the prediction (and subsequent removal) of multiplicative and additive temporal noise in the frequency domain. The combination of these two forms of processing allow the network to enforce stable intensity changes and minimize disruptive fluctuations.

The network is jointly trained with a structural reconstruction and temporal consistency loss. Global and local distortions are synthetically introduced to mimic flickering and jittering artifacts. With this simulation, distorted and clean pairs of videos are generated as training data. The network is trained to reconstruct the clean (visually appealing) video from the distorted (visually unappealing) video, thereby learning artifact correction.

The method of spatial artifact correction is described herein. The noise characteristics in GenAI videos were empirically determined to follow substantially different distributions than natural video content. Therefore, existing denoising algorithms, which are designed for natural content, do not achieve full efficacy on generative video. ArtifactNet, having been trained on a wide range of input domains, is able to isolate out critical features of input frames and subsequently perform denoising in a way which adapts to the domain of the input content.

The spatial branch of ArtifactNet utilizes a series of convolutional layers to create a highly compressed latent representation of the input luminance and chrominance features, effectively distilling the input to only its most important components. Throughout the layers of processing, information is efficiently shared between channels, allowing the network to learn to produce outputs which are aligned across the data's channels. The feature map is internally distilled to an extremely narrow and deep abstract representation. The frame is subsequently reconstructed from the latent representation to form the final processed output. The training setup utilizes regularization in the DCT domain as an optimization objective, allowing the network to learn to intelligently condense the important components of the image signal into a smaller set of frequency components, removing unwanted noise in the process.

Similar to the temporal branch, artifacts are manually introduced from various distributions and sources (e.g. Poisson, Gaussian, etc.) to form degraded input frames during training. The network learns to process degraded inputs into the original high quality ground truth frame via perceptually-oriented models of visual similarity, all while maintaining compressibility with frequency-domain regularization. Essentially, the optimization function includes both a reconstruction and compressibility component—the carefully weighted combination of these objectives allows the network to learn how to remove non-essential high-frequency noise while preserving critical visual details.

The compressibility component of the optimization is described in detail below. The most optimal method of modeling compressibility would be to take the processed frames and directly run a given codec algorithm to encode the video. However, that is not a differentiable operation. Furthermore, previous methods which involve the training of auxiliary networks to model the relevant entropy distributions are computationally heavy and do not always generalize well. As such, ArtifactNet is trained with a compressibility metric which directly measures the “compactness” of the energy within a frame's DCT frequency coefficients. This function is essentially designed to emulate what is, compressibility-wise, most efficient for a codec to encode. Furthermore, the measurement of energy compactness is fully differentiable and produces smooth gradients for ArtifactNet's spatial network to optimize on. This noise suppression objective is explicitly tuned to the unique low kurtosis statistical property of high frequency components for GenAI content.

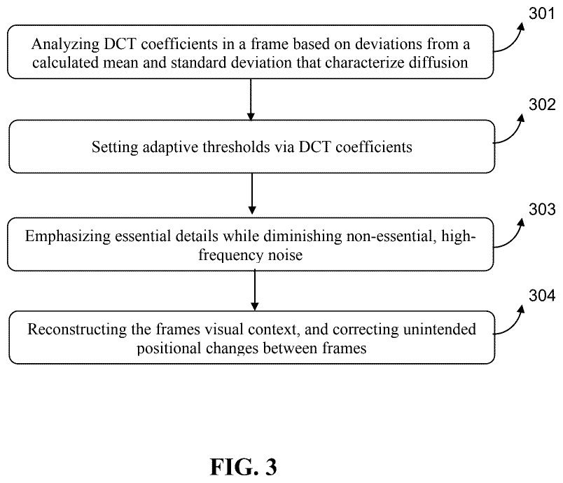

FIG. 3 illustrates a method of high frequency noise suppression. This method effectively differentiates structured visual details from stochastic noise by leveraging statistical deviations in DCT coefficients, allowing for selective suppression of high-frequency artifacts. By dynamically adjusting thresholds based on these deviations, the system maintains visual fidelity while reducing redundant noise patterns that arise from generative processes.

Analyze DCT coefficients in a frame based on deviations from a calculated mean and standard deviation that characterize diffusion outputs 301. Set adaptive thresholds via DCT coefficients 302. Emphasize essential details while diminishing non-essential, high-frequency noise. Emphasize essential details while diminishing non-essential, high-frequency noise 303. Reconstruct the frames visual context, and correct unintended positional changes between frames 304.

In one exemplary embodiment, the spatial attention module is designed to generate a spatial attention mask that highlights important regions in a spatial feature map, much like the attention mechanism utilized in large-language models. However, we replace the query-key structure with a series of convolutions for computational efficiency. The convolutions capture a broad receptive field and utilize downstream max pooling operations to extract the most dominant spatial activations. These activations are further processed in their compressed representations and subsequently upsampled back to the original spatial resolution, ultimately producing a spatial attention mask, which is applied to the original image signal. This allows the network to efficiently amplify more critical spatial regions and suppress less informative ones. Specifically, a 1×1 convolution (c1_=self.conv1(x)) extracts a preliminary feature embedding, followed by a dedicated path (cf=self.conv_f(c1_)) that preserves fine local details and a complementary pathway (c3=self.conv3(v_max))—obtained via spatial pooling—to capture broader global context. Furthermore, this configuration circumvents the quadratic computational overhead inherent in traditional non-local attention mechanisms, reducing complexity from O(H²W²) to O(HW) by limiting attention calculations to localized feature regions rather than performing dense pairwise interactions across the entire spatial feature map.

To expand spatial resolution without introducing excessive artifacts, we employ a PixelPhase Shift mechanism that operates as an inverse shuffle of channel data.

The operation restructures a feature map initially represented with (C×r², H, W) into (C, H×r, W×r), where:
C is the number of output feature channels, which remains unchanged to preserve the integrity of learned feature representations.
H and W denote the spatial height and width of the original feature map, which are expanded by a factor of r in each dimension, ensuring accurate pixel placement.
r is the scaling factor, determining the upsampling ratio by redistributing pixel information from the channel dimension into the spatial domain.

In essence, the operation takes each r*r subset of channels and maps them into a localized r*r region of the spatial grid. By maintaining the overall number of elements, the phase-shift ensures that no learned feature information is lost or merged incorrectly.

Unlike naive transposed convolutions—which may produce checkerboard artifacts due to overlapping kernel placements—the phase-shift approach methodically redistributes feature elements from the channel dimension to the spatial domain. This more direct re-mapping tends to yield smoother, more coherent upsampling results, significantly diminishing common aliasing effects and helping to preserve local details.

Parallel to these spatial innovations, ArtifactNet's temporal branch is similarly augmented to robustly capture and refine motion dynamics across video frames. The temporal module constructs a highly compressed representation of motion by isolating meaningful dynamics from spurious temporal noise, operating on multi-frame feature embeddings while preserving motion coherence across time. Unlike traditional per-frame processing methods, which operate on individual frames, this temporal module efficiently extends the spatial feature refinement concept across a sliding temporal window of frames (e.g., N=5). Within this window, the network constructs a motion-consistent latent representation by aligning feature embeddings across video frames, allowing it to distinguish between true motion and undesired temporal artifacts such as flicker and jitter.

Each motion-aligned latent representation is structured as (C×r², H, W, N), where:
C is the number of feature channels encoding feature representations.
r is the motion refinement factor, representing the granularity at which motion embeddings are refined, allowing finer motion estimation across adjacent frames.
H and W denote the spatial height and width of the latent feature map.
N represents the temporal window size, defining the number of consecutive frames processed simultaneously in the time domain.

The transformation into (C, H×r, W×r, N) redistributes motion-refined features by expanding both spatial resolution and channel representation proportionally to the learned refinement factor. The novelty of learning the motion refinement factor within the network lies in its ability to dynamically adapt to varying motion complexities, optimizing feature alignment at a per-sequence level rather than relying on rigid, handcrafted heuristics. Unlike traditional motion estimation techniques that enforce fixed algorithmic bounds, the neural network learns an optimal r-factor as part of its training process, adjusting refinement granularity based on observed motion patterns. This ensures higher adaptability across different frame rates, motion speeds, and scene complexities, ultimately leading to smoother motion representations.

This integration enables the temporal branch to enforce consistent inter-frame intensity variations and suppress local jitter, thereby ensuring that both global and localized temporal artifacts are effectively mitigated. The combined spatial and temporal enhancements yield a system where visual motion artifacts and data compressibility are concurrently optimized, showcasing a technical breakthrough that significantly elevates Gen-AI video enhancement.

Described herein is our method of constructing a novel optimization objective with adaptive thresholding in the DCT domain. This approach dynamically scales penalty terms based on frequency-specific noise characteristics, allowing the neural network to selectively suppress artifacts without over-smoothing critical details. The loss function is part of the network training schema that allows it to intelligently learn the underlying difference between detail and noise.

Each DCT coefficient C(i,j) is compared against a mean and standard deviation (mean(i,j), std_dev(i,j)) derived from the noise profile of the frequency band it falls under (low, medium, or high). The mean magnitude is scaled by a constant which is unique to the frequency band. The framewise DCT coefficients are then penalized based on whether they fall below or above the threshold, allowing the noise suppression to perform more aggressive regularization on higher frequencies. The network essentially learns to consolidate the frame's signal into a smaller set of coefficients, maximizing the retention of visually significant information while filtering out redundant noise. Due to the low kurtosis in the distribution of high frequencies in AI-generated content, it is appropriate to apply a more aggressive regularization to high-frequency DCT coefficients.

Regularization and Adaptive Thresholding: The regularization function for each DCT coefficient is defined as follows. Let C(i,j) represent the DCT coefficient at spatial position (i,j) in a given frame. We define an importance score S(i,j) for each coefficient as:

$$S ( i , j ) = \vert C ( i , j ) - mean ( i , j ) \vert$$

where mean(i,j) is the mean of the coefficient magnitude distribution for the given frequency band.

The adaptive threshold T(i,j) is then defined as:

$$T ( i , j ) = alpha * mean ( i , j )$$

with alpha being a hyperparameter that controls the amount of regularization to be applied to that frequency band.

The regularization penalty R(C(i,j)) is formulated as:

$$R ( C ( i , j ) ) = lambda * ReLU ( T ( i , j ) - S ( i , j ) ) * \vert C ( i , j ) \vert$$

Here, lambda sets the penalty weight, and the function ReLU(T(i,j)−S(i,j)) applies the penalty only when a coefficient falls below the adaptive threshold. High-frequency components receive more aggressive regularization by scaling the threshold, ensuring progressively stronger regularization of higher frequencies, suppressing extraneous noise while retaining essential detail.

ArtifactNet's dual-module design effectively eliminates jitter, ghosting, and banding effects that would otherwise degrade video quality during encoding. By leveraging techniques tailored to the artifact patterns inherent in GenAI content, it delivers sharper visuals, smoother motion, and an overall seamless viewing experience. By enhancing visual consistency and removing unnecessary high frequency noise, it also improves the efficiency of video codecs, enabling better compression and playback optimization for ArtifactNet-processed GenAI videos. Furthermore, ArtifactNet is model and codec-agnostic, making it applicable across various generative video models and encoding setups.

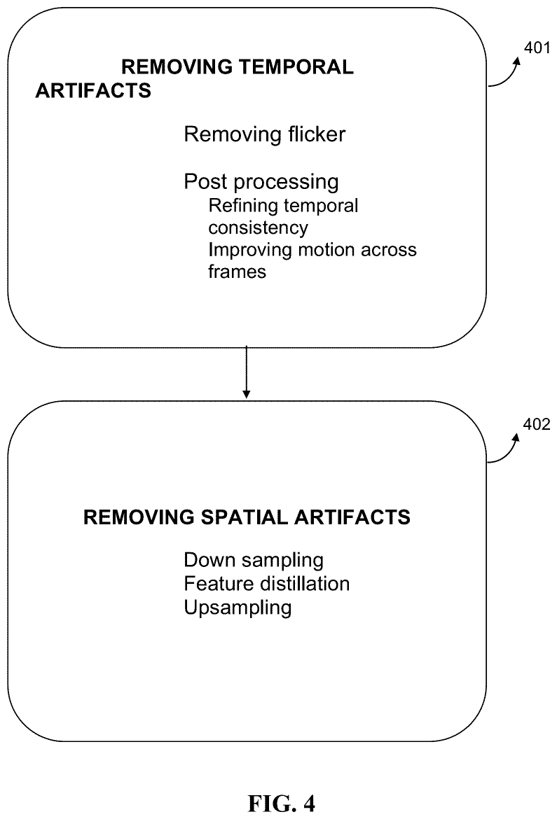

FIG. 4 illustrates the Temporal+Spatial modules integrated together in full processing. This integrated approach ensures a holistic correction of both temporal and spatial inconsistencies by first stabilizing motion dynamics and then refining spatial details. Temporal artifact removal 401 prioritizes flicker suppression and motion coherence, preventing erratic luminance shifts that disrupt visual flow. The subsequent spatial refinement leverages downsampling, feature distillation, and upsampling 402 to preserve essential textures while eliminating non-structured high-frequency noise, ultimately optimizing the perceptual quality of GenAI-generated video.

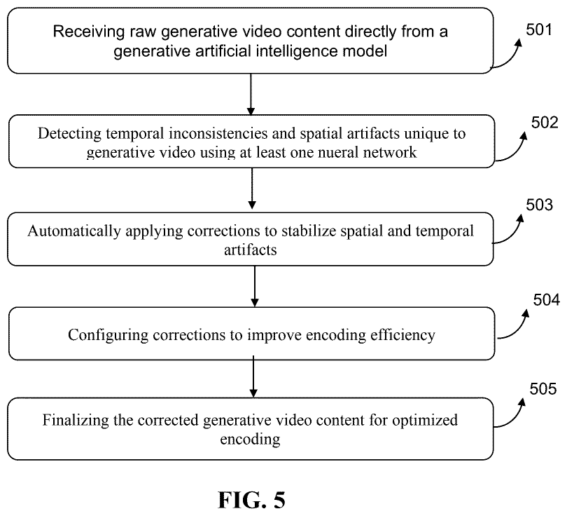

FIG. 5 illustrates a method for pre-processing generative AI produced video content to correct visual artifacts prior to encoding. Receive raw generative video content directly from a generative artificial intelligence model 501. Detect temporal inconsistencies and spatial artifacts unique to generative video using at least one neural network 502. Automatically apply corrections to stabilize spatial and temporal artifacts 503. Configure corrections to improve encoding efficiency 504. Finalize the corrected generative video content for optimized encoding 505.

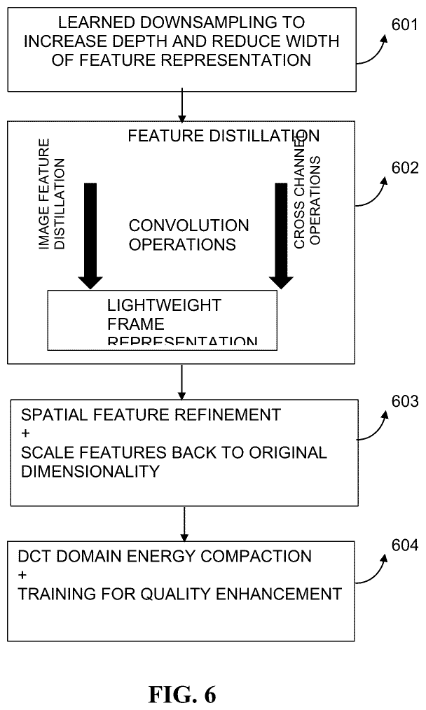

FIG. 6 illustrates the end-to-end spatial branch of the convolutional neural network. This neural network architecture optimally compresses and refines spatial features by leveraging learned downsampling 601 and feature distillation 602, ensuring efficient representation with minimal information loss. The final stage applies DCT-domain energy compaction 604, enhancing perceptual quality while maintaining computational efficiency, making it well-suited for generative AI video processing.

Real-Time Processing Framework (CNN used for spatial artifact correction) illustrates a framework for lightweight, real-time (60 frames-per-second @ 1080p resolution) processing of generative AI video frames. A loss function is integrated within the convolution-based processing network's training setup enables GenAI video content to retain necessary structural detail while minimizing high-frequency noise artifacts, resulting in cleaner, sharper videos which can be efficiently compressed. The novelty of this approach lies in its use of lightweight convolutional layers to perform both feature distillation and refinement 603 as well as the highly optimized cost functions used during training. By processing the luma and chroma channels as a unified entity, the system preserves cross-channel dependencies, ensuring consistent color gradients and preventing artifacts like color drift. Standard convolutional operations are used to efficiently extract spatial, spectral, and channel-wise features, achieving high-fidelity outputs with minimal computational overhead.

The foregoing examples have been provided for explanation and are in no way to be construed as limiting the method of adaptive frame stabilization and color correction in generative AI-produced video content. The design and functionality of the system extend to all functionally equivalent methods and uses, and modifications or other embodiments may be implemented without departing from the scope and spirit of the invention.

The processing steps described above may be implemented as modular components within a scalable system architecture. As used herein, a module refers to a functional unit that can execute one or more aspects of the present invention, implemented via hardware, software, or a combination thereof. This neural network can be deployed as a compiled model with the pretrained weights on a cloud-based instance, allowing real-time artifact correction for Gen-AI videos. For example, the model can be containerized and executed on a virtualized cloud instance (e.g., Amazon™ MEC2 Inf2) for high-throughput inference and can also sit within the same workflow as the generative creation and the subsequent video encoding. In a typical workflow, an incoming generative video stream is fed into the network for correction and the output frames are efficiently encoded before being streamed. In implementation, the various modules described herein might be implemented as discrete modules or the functions and features described can be shared in part or in total among one or more modules. In other words, as would be apparent to one of ordinary skills in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

In general, the modules/routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices among others.

While the inventive concepts described herein with reference to illustrative embodiments for particular applications, it should be understood that the inventive concepts are not limited thereto. Those having ordinary skill in the art and access to the teachings provided herein will recognize additional modifications, applications, embodiments and substitution of equivalents all fall within the scope of the inventive concepts. Accordingly, the inventive concepts are not to be considered as limited by the foregoing description.

What is claimed as new and desired to be protected by Letters Patent of the United States is:

1. A computer implemented method for adaptive frame stabilization and noise removal in generative artificial intelligence produced video content, the method executable by at least one processor configured to execute computer program instructions for performing the method, the method comprising the steps of:
applying an end-to-end trained temporal neural network to said generative artificial intelligence produced video content to detect and correct flicker patterns, wherein global flicker is classified as multiplicative or additive errors, and local flicker is detected as unintentional object jitter;
applying said temporal neural network across the generative artificial intelligence produced video content, distinguishing between true object motion and flicker artifacts, and stabilizing brightness inconsistencies while preserving motion integrity;
ensuring frame-to-frame coherence by reconstructing each frame of the generative artificial intelligence produced video content's visual context, and correcting unintended positional variations, thereafter producing a stabilized temporally corrected output;
passing said stabilized temporally corrected output into a spatial neural network trained to enhance color consistency, suppress high-frequency noise, and refine luminance and chrominance channels through convolutional and cross-channel operations;
applying frequency-adaptive discrete cosine transform (DCT)-based regularization to said passed temporally corrected output, selectively filtering non-essential noise while retaining perceptual detail; and
generating a fully refined video output where temporal and spatial artifacts have been minimized, ensuring optimal video quality for encoding and playback.

2. The computer implemented method of claim 1, wherein targeted corrections are applied to ensure stable visual consistency across frames of said generative artificial intelligence produced video content.

3. The computer implemented method of claim 1, wherein a loss function integrated within the convolution-based processing network's training setup enables generative artificial intelligence video content to retain necessary structural detail while minimizing high-frequency noise artifacts, resulting in cleaner, sharper videos which can be efficiently compressed.

4. A system for adaptive frame stabilization and noise removal in generative artificial intelligence produced video content, comprising;
at least one processor;
a non-transitory computer readable storage medium communicatively coupled to said at least one processor, said non-transitory computer readable storage medium configured to store modules, said at least one processor configured to execute said modules; and
said modules comprising:
a first module for,
applying an end-to-end trained temporal neural network to said generative artificial intelligence produced video content to detect and correct flicker patterns, wherein global flicker is classified as multiplicative or additive errors, and local flicker is detected as unintentional object jitter;
applying said temporal neural network across the generative artificial intelligence produced video content, distinguishing between true object motion and flicker artifacts, and stabilizing brightness inconsistencies while preserving motion integrity;
ensuring frame-to-frame coherence by reconstructing each frame of the generative artificial intelligence produced video content's visual context and correcting unintended positional variations, thereafter producing a stabilized temporally corrected output;
a second module for,
passing said stabilized temporally corrected output into a spatial neural network trained to enhance color consistency, suppress high-frequency noise, and refine luminance and chrominance channels through convolutional and cross-channel operations;
a third module for,
applying frequency-adaptive discrete cosine transform (DCT)-based regularization to said passed temporally corrected output, selectively filtering non-essential noise while retaining perceptual detail; and
thereby generating a fully refined video output where temporal and spatial artifacts have been minimized, ensuring optimal video quality for encoding and playback.

5. A computer implemented method for pre-processing generative AI-produced video content to correct visual artifacts prior to encoding, the method executable by at least one processor configured to execute computer program instructions for performing the method, the method comprising:
receiving raw generative video content directly from a generative artificial intelligence model;
detecting temporal inconsistencies and spatial artifacts unique to generative video in said raw generative video using at least one neural network;
automatically applying corrections to stabilize said temporal inconsistencies and temporal artifacts, thereby ensuring positional coherence, consistent luminance, and inter-frame stability;
configuring said corrections to improve encoding efficiency by reducing redundant noise, unnecessary motion vectors, and high-frequency inconsistencies; and
finalizing the corrected generative video content for optimized encoding, thereby guaranteeing playback fidelity and efficient compression with existing codecs.

6. The computer implemented method of claim 5, wherein said temporal inconsistencies comprise brightness flicker and unintended object jittering.

7. The computer implemented method of claim 5, wherein said spatial artifacts comprise unwanted high frequency noise.
